(19) United States
(12) Patent Application Publication
(10) Pub. No.: US 2003/0046233 A1
(43) Pub. Date: Mar. 6, 2003

(54) Automatic transaction apparatus and control method therefor

(75) Inventors: Mari Ara, Yamato-shi (JP); Tsutomu Sawa, Fujisawa-shi (JP); Kohhei Shibata, Yamato-shi (JP)

Correspondence Address: IBM Corporation, Personal and Printing Systems Group Legal Dept., Dept. 9CCA/Bldg. 002-2, P.O. Box 12195, Research Triangle Park, NC, 27709, US

(73) Assignee: International Business Machines Corporation, Armonk, NY

(21) Appl. No.: 10/190,021

(22) Filed: Jul. 3, 2002

(30) Foreign Application Priority Data
Aug. 29, 2001 (JP) 2001-259517

(51) Int. Cl. G06F 17/60

(52) U.S. Cl. 705/43

(57) ABSTRACT

According to the present invention, an automatic transaction apparatus, which provides usability commensurate with capabilities of a user, comprises: notification means for notifying the user of the contents of an operation; operating means for receiving an instruction from the user; detection means for detecting the operating state of the user; control means for controlling the usability of the operating means based on the operating state detected by the detection means; and reading/recording means for reading the operating state and control parameters from the memory of the card, or writing them thereto.

### BACKGROUND OF THE INVENTION

1. The Field of the Invention

The present invention relates to the field of automatic transaction devices and more particularly, to an apparatus and method for conducting a transaction using an automatic transaction apparatus in which a user employs a card having a memory.

2. Background of the Art

An automatic transaction apparatus, such as an automatic telling machine (ATM), conducts a transaction in response to a user's manipulation of operating means (such as an operation panel) in accordance with operational guidance provided by the apparatus. It is known that an automatic transaction apparatus may be employed by a diversity of representing a broad generational range, such as users inclusive of children and the elderly alike. Therefore, in the marketplace, it has become common for an automatic transaction apparatus to be required to be operable (also used herein as “manipulated”), by most all users ranging from children to senior citizens.

However, given the diversity of users, it is very difficult to provide optimal usability to all users concurrently, and conventionally, therefore, the performance of an automatic transaction apparatus has been optimized based on the assumption it will be suitable for a standard user employed. The definition of a “standard user” is typically determined by the automatic transaction apparatus vendor, purchaser or designer, and this standard user is based upon a profile of a typical user. This standard user profile is then used as a reference with regard to the automatic transaction apparatus.

Since a standard user profile may be used to develop an automatic transaction apparatus, when the apparatus is thereafter used by children, the children may find that the apparatus is not convenient for their use. Similarly, based on a similar design basis, elderly people or the physically handicapped (hereinafter referred to as physically-challenged people and is inclusive of individuals who are visually, aurally or similarly challenged) may also find the use of the apparatus less than desirable or satisfactory. In addition, even what may be viewed as more of a typical users or a user approximating the “standard user” profile, such as those of middle age without physical challenges, may also not be able to manipulate an automatic transaction apparatus because they are not familiar with its operation.

In order to improve an automatic transaction appartus usability for physically-challenged people, an automatic transaction apparatus is disclosed in Japanese Unexamined Patent Publication No. Sho 62-180469. This automatic transaction apparatus reads from a card a flag that is used to identify a physically handicapped user, and increases the size of the characters printed by the apparatus or the output volume.

However, since the automatic transaction apparatus in the above mentioned publication merely uniformly increases the sizes of printed characters or the output volume when the flag identifying a physically handicapped user is read, usability is not always improved for all physically handicapped people. That is, the automatic transaction apparatus presented in the above publication does not improve usability commensurate with the needs of all physically handicapped individuals (differences between individuals and physical challenges exist). In addition, the method disclosed in the publication is not especially effective for physically-challenged people other than those who are physically handicapped with limitations resolved by the publication.

An automatic transaction apparatus is also disclosed in Japanese Unexamined Patent Publication No. Sho 63-138462. This automatic transaction apparatus calculates the age of a user based on the birthday of the user that is read from an IC card, and in accordance with the user's age, increases the size of the characters in the guidance displayed displaced on a screen. Further, also in accordance with this publication, the sizes of the characters used for the guidance that is displayed is increased in accordance with eyesight information read from the IC card.

However, since the apparatus in this publication, as well as the one disclosed in Japanese Unexamined Patent Publication No. Sho 62-180469, uniformly increases the sizes of characters in accordance with the age and the eyesight of a user, the usability is not improved in accordance with the needs of individual users (a difference between the individuals). Additionally this publication assumes a specific need based on a user's age which may not be suitable to all users uniformly with regard to their age. The method described in the publication is not especially effective for physically-challenged people who have needs outside of the uniform solution.

An automatic transaction apparatus is also disclosed in Japanese Unexamined Patent Publication No. Hei 7-28920. With this apparatus, the hearing level may be altered to conform with the needs of a user. However, in order to adjust the automatic transaction apparatus to obtain an appropriate hearing level, a user must set the hearing level each time the apparatus is used. This further complicates the use of the apparatus by requiring the user to perform an addition operation. Additionally, this further step contributes to the deterioration of the speed of an automatic transaction and impacts others who may be waiting.

### SUMMARY OF THE INVENTION

Therefore, what is needed is a user-friendly automatic transaction apparatus that can be easily manipulated (i.e., operated) by individual users, and a control method therefor.

An object of the present invention to provide a user-friendly automatic transaction apparatus that can be easily manipulated by individual users, and a control method therefor.

Another object of the present invention is to provide an automatic transaction apparatus that monitors the operating state of a user and automatically improves usability commensurate with the needs of the user, and a control method therefor.

According to one aspect of the present invention, an automatic transaction apparatus, which provides usability commensurate with the capabilities of a user, comprises: notification means for notifying the user of the contents of an operation; operating means for receiving an instruction from the user; detection means for detecting the operating state of the user; and control means for controlling the usability of the operating means based on the operating state detected by the detection means.

Further, according to another aspect of the present invention, a method for controlling an automatic transaction apparatus having operating means manipulated by a user comprises: (a) a notification step of notifying a user of the contents of a manipulation of the operating means; (b) a detection step of detecting the operating state of the operating means manipulated by the user; and (c) a control step of controlling the usability of the operating means based on the detected operating state.

According to a further aspect of the present invention, a method for controlling an automatic transaction apparatus that includes operating means manipulated by a user, and card acceptance means for accepting a card including a memory and for reading information from or writing information to the memory of the card, comprises the steps of: (a) notifying a user of the contents of the manipulation of the operating means; (b) accepting a card; (c) reading information, related to an operating state, that is stored in the memory of the card; (d) controlling the operating means based on information, related to the operating state, that is read; (e) detecting the operating state of the operating means manipulated by the user; (f) controlling the operating means based on the operating state that is detected; and (g) storing information for the modified operating state in the memory of the card.

Unless otherwise specified herein, an automatic transaction apparatus includes any automatic transaction apparatus, such as an automatic teller machine (ATM), a cash dispenser (CD), an automatic contract machine, a money exchange machine, a vending machine and/or an information terminal, such as a KIOSK, without limitation only to the examples stated here. Further, unless otherwise specified, a card used for this specification is any type of card, such as a cash card or a credit card, or any type of memory card, such as a magnetic card or an IC card.

### BRIEF DESCRIPTION OF THE DRAWINGS

Other aspects, features, and advantages of the present invention will become more fully apparent from the following detailed description, the appended claims, and the accompanying drawings in which:

FIG. 1 is a diagram showing the external appearance of an automatic teller machine (ATM) as an automatic transaction apparatus, according to one embodiment of the present invention.

FIG. 2 is a block diagram showing the internal configuration of an ATM according to the embodiment of the present invention.

FIG. 3 is a diagram depicting the configuration of a control means according to an aspect of the present invention.

FIG. 4 is a flowchart depicting the processing performed by a control method according to an aspect of the present invention.

### DETAILED DESCRIPTION OF THE PREFERRED EMBODIMENTS

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings.

A preferred embodiment of the present invention will now be described while referring to the accompanying drawings.

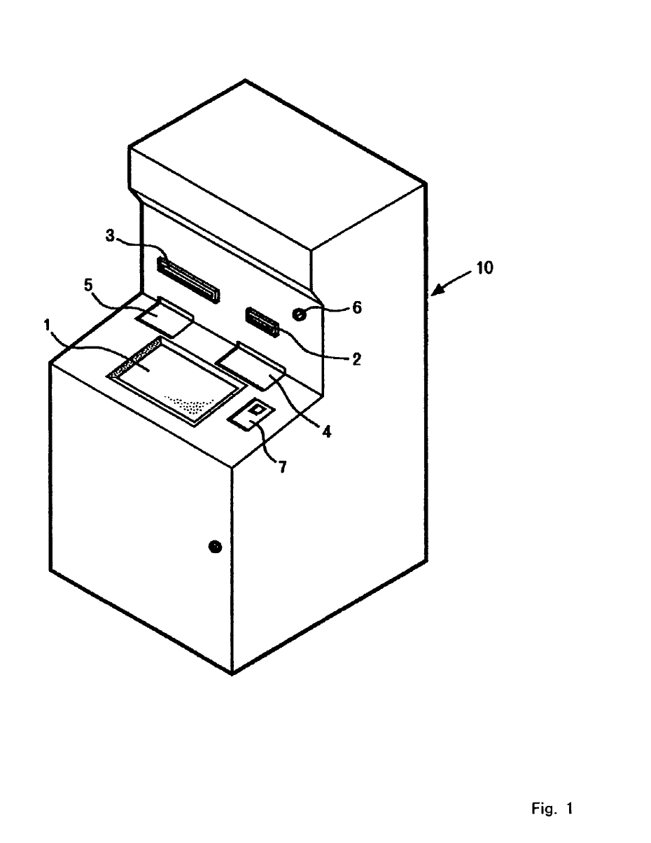

FIG. 1 is a diagram showing the external appearance of an automatic teller machine (ATM) 10, an automatic transaction apparatus, according to one embodiment of the present invention. The ATM 10 of FIG. 1 comprises: a touch input type display (hereinafter referred to as a touch panel) 1; card acceptance means 2 having a card insertion slot; bankbook acceptance means 3 having a bankbook insertion slot; bill acceptance means 4 having a bill insertion slot; coin acceptance means 5 having a coin tray; voice output means 6 having a loudspeaker, and a calculator 7. When an operation (transaction) menu and numbers that are displayed on the touch panel 1 are touched by a finger, the coordinate data of the transaction type or the number that has been touched is input to the ATM 10, and the selected transaction type or number is identified.

For a transaction conducted by the ATM 10 in FIG. 1, a user performs the following operation in accordance with guidance displayed on the touch panel 1 or audibly reproduced through the loudspeaker:

(a) The user selects, on the touch panel 1, a displayed transaction menu (deposit, withdrawal, money transfer or remittance) and enters his or her pin number;

(b) The user feeds in or removes from the card acceptance means 2 a cash card or a credit card, or obtains transaction specifications therefrom;

(c) The user employs the bankbook acceptance means 3 to insert and remove a bankbook;

(d) The user inserts and removes bills at the bill acceptance means 4; and,

(e) The user deposits or extracts coins at the coin acceptance means 5.

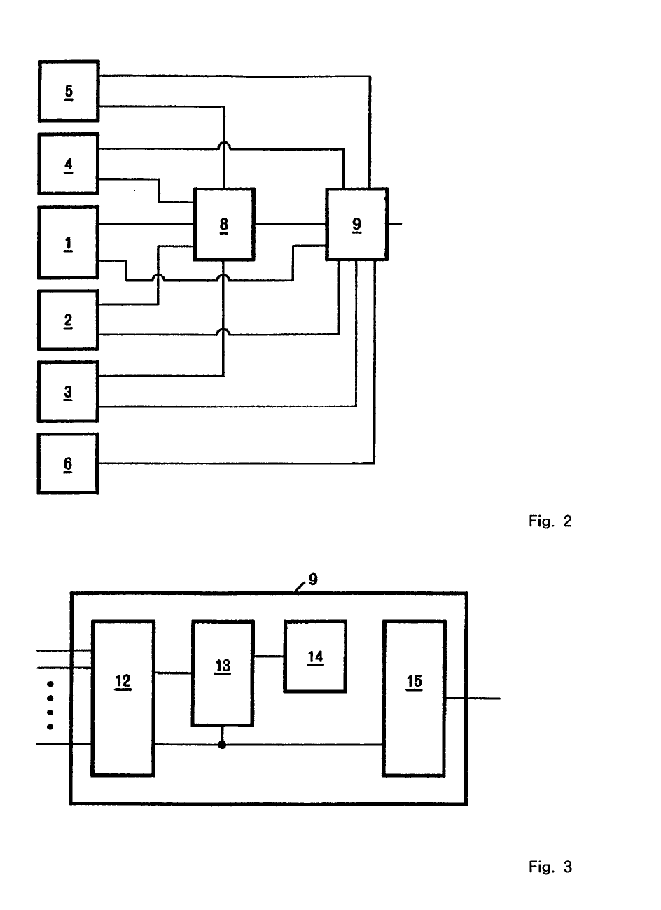

FIG. 2 is a block diagram showing the internal configuration of the ATM 10. The components 1 to 6 in this configuration correspond to the touch panel 1, the card acceptance means 2, the bankbook acceptance means 3, the bill acceptance means 4, the coin acceptance means 5 and the voice output means 6. Further, detection means 8 and control means 9 are also provided in FIG. 2. The detection means 8 is connected to the components 1 to 6, and the control means 9 is connected to the components 1 to 6 and the detection means 8.

The touch panel 1 has a function for displaying an operation (transaction) menu and a function for accepting an entry, such as a selected transaction type. The card acceptance means 2 includes a function for receiving or discharging a card through the insertion slot and a function for reading information from or writing information to the card. The card acceptance means 2 can be a device that can read information from or write information to the magnetic stripe of a magnetic card, or a device that can read information from or write information to the memory of an IC card. The bankbook acceptance means 3 includes a function for receiving or discharging a bankbook through the insertion slot, a function for reading information from or writing information to a magnetic stripe attached to the bankbook, a function for printing transaction data in the bankbook, a function for identifying a page mark and a function for turning over a page. The bill acceptance means 4 includes a function for receiving bills through the insertion slot and for examining them for counterfeits or for counting them, a function for storing bills, and a function for discharging bills. The coin acceptance means 5 includes a function for receiving coins on the tray and for examining them for counterfeits or for counting them, a function for storing coins, and a function for discharging coins. The voice output means 6, which is equipped with a loudspeaker, generates sounds, or voice output for providing audible guidance for a user.

The detection means 8 includes time counting means (a counter), and on the control means 9 may employ time counting software to provide the counter. The detection means 8 detects a representative operating state for a user. In this embodiment, the operating state reflects the reaction speed (time) of the user, i.e., the response speed (time), and is based, for example, on the following:

(A) The period of time that elapsed, following the display of a transaction menu (a deposit, withdrawal or money transfer) on the touch panel 1 or the provision via the loudspeaker of audible guidance for the selection of a transaction type, before one of the transaction types was selected;

(B) The period of time that elapsed, following the display on the touch panel 1 of an instruction or the provision via the loudspeaker of audible guidance to input a pin number, before the entry of the pin number was completed;

(C) The period of time that elapsed, following the display on the touch panel 1 of an instruction or the provision via the loudspeaker of audible guidance to insert a card, before the card was actually inserted into the card acceptance means 2;

(D) The period of time that elapsed, following the discharge of a card from the card acceptance means 2 or the provision via the loudspeaker of audible guidance to remove the card, before the card was removed from the slot of the card acceptance means 2;

(E) The period of time that elapsed, following the display on the touch panel 1 of an instruction or the provision via the loudspeaker of audible guidance to insert a bankbook, before the bankbook was inserted into the bankbook acceptance means 3;

(F) The period of time that elapsed, following the discharge of a bankbook from the slot of-the bankbook acceptance means 3 or the provision via the loudspeaker of audible guidance to remove the bankbook, before the bankbook was removed from the slot of the bankbook acceptance means 3;

(G) The period of time that elapsed, following the display on the touch panel 1 of an instruction or the provision via the loudspeaker of audible guidance to insert bills, before bills were inserted into the bill acceptance means 4;

(H) The period of time that elapsed, following the discharge of bills from the slot of the bill acceptance means 4 or the provision via the loudspeaker of audible guidance to remove the bills, before the bills were removed from the slot of the bill acceptance means 4;

(I) The period of time that elapsed, following the display on the touch panel 1 of an instruction or the provision via the loudspeaker of audible guidance to insert coins, before coins were inserted into the coin acceptance means 5; and,

(J) The period of time that elapsed, following the output of coins on the tray of the coin acceptance means 5 or the provision via the loudspeaker of audible guidance to remove the coins, before the coins were removed from the tray of the coin acceptance means 5.

The information for the operating time (speed) that is detected by the detection means 8 as the time required by the user is transmitted to the control means 9. As is shown in FIG. 3, the control means 9 includes input/output means 12 for exchanging a signal with the touch panel 1; a CPU 13 for performing computations; a memory 14; and transmission/reception means 15 for exchanging information with a host computer along a communication line. The control means 9 controls the operations of the touch panel 1, the card acceptance means 2, the bankbook acceptance means 3, the bill acceptance means 4, the coin acceptance means 5 and the voice output means 6. Among the parameters used by the control means 9, example control contents (control parameters) particularly associated with the manipulations performed by a user are shown below:

(1) Control of the touch panel 1: the sizes, the colors and the brightness (contrast) of characters and numbers to be displayed, the speed at which screens are to be switched, the waiting time, and the sizes of the input buttons of the touch panel 1 (the size of the area that is identified as an entry by touching the panel with a finger);

(2) Control of the voice output means 6: the volume of the audible guidance and the pitch of a tone, the speaking speed, the period of time that must elapse following the display on the touch panel 1 of the transaction menu or an operating instruction before via the loudspeaker audible guidance containing the same contents is output (waiting time before the voice instruction is output), and the number of repetitions of the audible guidance.

For further exemplification, and without limitation to the present invention, a further aspect of the present invention is provided wherein the control means 9 controls the touch panel 1 and the voice output means 6 in order to provide optimal usability for each user.

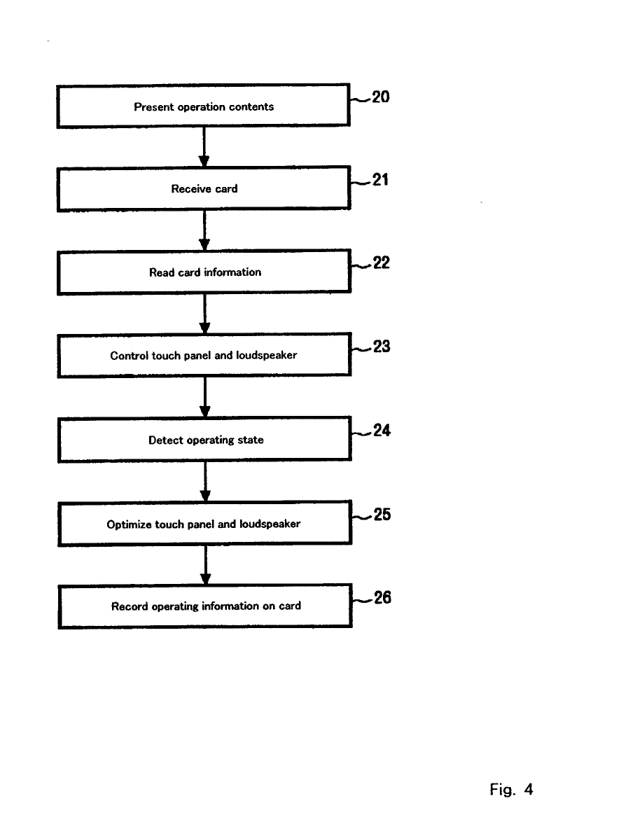

FIG. 4 is a flowchart showing the processing performed by the control means 9. In the following explanation, the operating information is stored in the memory of a card; however, the storage of data in the memory of a card is not a prerequisite to, limitation of nor requirement to the present invention.

First, notification of the operation contents is provided for the user (step 20). For this notification, a transaction menu (deposit, withdrawal and money transfer) is displayed on the touch panel 1, or audible guidance for making a selection from a transaction menu is provided via the loudspeaker. In order to present this notification, the control means 9 issues an instruction to the touch panel 1 and the voice output means 6. Then, the control means 9 receives a card that is inserted by the user through the card acceptance means 2 (step 21), and reads the information recorded on the card (step 22). The card information that is read is data that is added to the general information (a bank ID, an account number, etc.) on the magnetic card and that relates to the operating skill of the user. Specifically, the card information corresponds to a part or all of the parameters, controlled by the control means 9, that include:

(1) the sizes, colors and brightness (contrast) of characters and numbers displayed on the touch panel 1, the speed for the switching of screens and a waiting time, and the sizes of the input buttons for the touch panel 1; or

(2) the volume of the audible guidance and the pitch of a tone of the voice output means 6, the speaking speed, the period of time that should elapse, following the display on the touch panel 1 of the transaction menu or an operating instruction before the provision via the loudspeaker of the same contents as audible guidance (waiting time before voice output is provided), and the number of repetitions for the audible guidance.

Next, based on the obtained operating information for the user, the control means 9 controls the touch panel 1 and the voice output means 6 (step 23). That is, the touch panel 1 and the voice output means 6 are customized in accordance with the user. When, for example, the control means 9 obtains card information indicating the sizes of characters on the touch panel 1 should be increased, the control means 9 issues an instruction to the touch panel 1 to enlarge the displayed characters. Further, parameters such as the screen switching speed and the waiting time for the touch panel 1, or the volume and the pitch of the audible guidance provided via the loudspeaker are changed based on the parameter information that is recorded on the card. As a result, the usability of the ATM 10 is customized for the pertinent user. When operating information for the user is not recorded on the card, such as when a new card is employed for the ATM 10, the customizing is not performed, and a predetermined standard operating setup is used to provide operating control for the touch panel 1.

The detection means 8 detects the operating state of the user (step 24). The operating state can be one or more operating speeds (times) for the user selected from among ten types (A) to (J), such as “(B) the period of time following the display on the touch panel 1 of an instruction or the provision of audible guidance by a loudspeaker to enter a pin number until the entry of the pin number is completed”. Then, the control means 9 receives the detected operating state (speed) of the user, and optimizes the touch panel 1 and the voice output means 6 (step 25). Optimization means that the optimal usability (operating environment) for the user is provided.

A further discussion for an exemplary optimization of an aspect of the present invention wherein the speed (waiting time) T for switching the screens of the touch panel 1 is controlled is provided.

Two references, “0”: standard time (no waiting) and “1”: waiting (arbitrary predetermined time is added to the standard time), are set as control parameters for the waiting time T for the screen of the touch panel 1. The references are not limited to two, and three or more references may be set. The detection means 8 detects the response speeds (times) for the user, e.g., (A) the period of time (T1) following the display on the touch panel 1 of the transaction menu (deposit, withdrawal or money transfer) before one of the transaction types is selected, and (B) the period of time (T2) following the display on the touch panel 1 of an instruction to input a pin number before the entry of the pin number is completed. Based on an assumption that the timings will be for a standard user (i.e., a predetermined timing), t1 second and t2 second are set in advance as reference values of T1 and T2.

The control means 9 (CPU 13) receives the detected time data (T1 and T2), and compares the time data (T1 and T2) with the time data (T10 and T20) that are read from the card. If the detected time data T1 (T2) is larger than a limit value A (a×t1 (t2), wherein a denotes a arbitrary constant determined in advance, for example, a=42) obtained by multiplying the standard time t1 (t2) by a constant magnification rate (a), the detected data T1 (T2) is regarded as invalid data, and is not employed. Therefore, a case wherein an operation is delayed due to a specific cause can be removed. If the time data T1 (T2) is smaller than the limit value A (e.g., 42×t1 (t2)), the detected data T1 (T2) is used as effective data. Then, the average value T1a (T2a) of the detected time data T1 (T2) and the time data T10 (T20) that is read is obtained. Subsequently, the average value T1a (T2a) is compared with a threshold limit value B (e.g., b×t1 (t2) wherein, as is a, b is an arbitrary constant determined in advance, e.g., b=2). When at the least, either average value T1a or T2a is larger than the threshold limit value B (e.g., 2×t1 (t2)), “1”: waiting (e.g., the standard time+one second) is employed as the control parameter for the waiting time for the screen of the touch panel 1. When the average values T1a and T2a are smaller than the threshold limit value B (e.g., 2×t1 (t2)), “0”: standard time is employed as the control parameter for the waiting time for the screen of the touch panel 1. The above described control method is merely an example, and an independent measurement value may be employed to determine the control parameter, or another determination method may be employed.

The control means 9 controls the touch panel 1 based on the control parameter “1” or “0” employed for the waiting time for the screen. As a result, when the information that is stored on the card for the control parameter for the waiting time for the screen is “0” (standard), and when the “1”: waiting (e.g., standard time+51 seconds) is employed, the waiting time for the screen of the touch panel 1 is increased about 51 seconds, for example. Therefore, a long display time before the user operation is terminated can be obtained even for a user who responds slowly to an operating instruction. In the above example, (A) the period of time (T1) that elapses, following the display on the touch panel 1 of the transaction menu (deposit, withdrawal or money transfer), before one of the transaction types is selected is detected, and (B) the period of time (T2) that elapses, following the display on the touch panel 1 of an instruction for the input of a pin number, before the entry of the pin number is completed is detected, and based on the detected times (T1 and T2), the speed (waiting time) T for switching the screens of the touch panel 1 is controlled. A combination of the detected time and the control parameters is an arbitrary combination of one or more of ten operating speeds (times) (A) to (J) and a part or all of the sizes, colors and brightness (contrast) of the characters and numbers displayed on the touch panel 1, the volume and the pitch of the audible guidance released by the voice output means 6, and the speaking speed. In other words, the same control method can be employed for other control parameters, such as the sizes of displayed characters and the volume of the audible guidance.

Through the process sequence, based on information (operating speed) that is actually detected and is related to the usability for a user, the ATM 10 can be automatically customized without an extra operation being required of the user, and the optimal state, wherein the user can easily manipulate the ATM 10, can be provided.

Following this, the control means 9 issues an instruction to the card acceptance means 2 to write, to the memory of the card, the operating information (e.g., T1 or T2) that was detected, or operating information (e.g., the average value for T1a or T2a) that is calculated, and the final control parameters. Therefore, when the ATM 10 is employed the next time, the stored information can be used as operating information acquired in the past, and at the same time, parameters can be prevented from being mistakenly changed due to a variance of one operating time. Further, the control means 9 stores, in a memory 14, the operating information (e.g., T1 or T2) that was detected, or operating information (e.g., the average value of T1a or T2a) that is calculated, and the final control parameters, and as needed, transmission means 15 can transmit the information and the parameters to an external host computer or to an external server.

The ATM 10 has been explained as an example, but the present invention can be applied for other automatic transaction apparatuses. According to the present invention, the following beneficial effects are readily obtained:

(1) Based on the operating information stored on the card, the performance of the automatic transaction apparatus is customized, and the customized performance is studied in accordance with information (operating state) that is actually detected concerning operating skill of the user. As a result, an operating environment that is more appropriate for the user can be provided automatically, without an extra operation being required if the user; and,

(2) therefore, since the user can manipulate the apparatus in an operating environment that is optimal for the user's operating skill, the user can efficiently and accurately perform a transaction using the automatic transaction apparatus, without any operating errors.

It will be further understood that various changes in the details, materials, and arrangements of the parts which have been described and illustrated in order to explain the nature of this invention may be made by those skilled in the art without departing from the principle and scope of the invention as expressed in the following claims. For instance, the use of varied or dynamic compression rates or rates commensurate with reducing space allocations required for various formats of data are envisioned herein.

What is claimed is:

1. An automatic transaction apparatus, which provides usability commensurate with capabilities of a user, comprising:
notification means for notifying said user of the contents of an operation;
operating means for receiving an instruction from said user;
detection means for detecting the operating state of said user; and
control means for controlling the usability of said operating means based on said operating state detected by said detection means.

2. The automatic transaction apparatus according to claim 1, wherein said control means, based on said detected operating state, control means for notifying said user of the contents of said operation.

3. The automatic transaction apparatus according to claim 1, wherein said control means, based on said detected operating state, controls said operating means so as to provide usability appropriate for said user.

4. The automatic transaction apparatus according to claim 2, wherein said control means, based on said detected operating state, controls said operating means for notifying said user of the contents of said operation so as to provide usability appropriate for said user.

5. The automatic transaction apparatus according to claim 1, wherein said detection means detects an operating speed or an operating time as the operating state of said user.

6. The automatic transaction apparatus according to claim 1, further comprising:
card acceptance means for accepting a card having a memory, and for reading information from or writing information to said memory of said card,
wherein said control means controls said card acceptance means so as to store, in said memory of said card, information that is related to said detected operating state.

7. The automatic transaction apparatus according to claim 6, wherein said control means controls said notification means and said operating means based on said information that is related to said operating state and that is read from said card by said card acceptance means.

8. A method for controlling an automatic transaction apparatus having operating means manipulated by a user comprising the steps of:
(a) a notification step of notifying a user of the contents of the manipulation of said operating means;
(b) a detection step of detecting the operating state of said operating means manipulated by said user; and
(c) a control step of controlling the usability of said operating means based on said detected operating state.

9. The method according to claim 8, wherein said control step (c) includes a step of:
(c1) controlling said operating means based on said detected operating state so as to provide usability appropriate for said user.

10. The method according to claim 8, wherein, at said detection step (b), an operating speed or an operating time of said operating means is detected as said operating state.

11. The method according to claim 8, wherein said automatic transaction apparatus includes a card acceptance means for accepting a card including a memory and for reading information from or writing information to said memory of said card, further comprising the steps of:
(d) accepting said card; and
(e) storing information that is related to said detected operating state in said memory of said card.

12. The method according to claim 11, further comprising the steps of:
(f) employing said card acceptance means to read, from said memory of said card, said information that is related to said operating state; and
(g) controlling said usability of said operating means based on said information, read from said memory of said card, that is related to said operating state.

13. The method according to claim 12, wherein said step (g) includes a step of:
comparing said information related to said operating state that is read from said memory of said card with information related to said operating state that is detected, and determining a parameter for controlling said operating means.

14. A method, for controlling an automatic transaction apparatus that includes operating means manipulated by a user and card acceptance means for accepting a card including a memory and for reading information from or writing information to said memory of said card, comprising the steps of:
(a) notifying a user of the results obtained by the manipulation of said operating means;
(b) accepting a card;
(c) reading information, stored in said memory of said card, that is related to an operating state;
(d) controlling said operating means based on said information that is related to said operating state;
(e) detecting the operating state of said operating means manipulated by said user;
(f) controlling said operating means based on said operating state that is detected; and
(g) storing in said memory of said card information that is related to said detected operating state.

15. The method according to claim 14, wherein said step (f) includes a step of:
comparing said information related to said operating state that is read from said card with said information related to said operating state that is detected, and determining a parameter for controlling said operating means.
